(19) United States
(12) Patent Application Publication
(10) Pub. No.: US 2025/0219268 A1
(43) Pub. Date: Jul. 3, 2025

(54) METHOD FOR DISPOSING OF BATTERY AND BATTERY

(71) Applicant: TOYOTA JIDOSHA KABUSHIKI KAISHA, Toyota-shi (JP)

(72) Inventors: Fuminori MIZUNO, Miyoshi-shi (JP); Hiroshi SUYAMA, Mishima-shi (JP)

(73) Assignee: TOYOTA JIDOSHA KABUSHIKI KAISHA, Toyota-shi (JP)

(21) Appl. No.: 18/977,578

(22) Filed: Dec. 11, 2024

(30) Foreign Application Priority Data
Dec. 28, 2023 (JP) 2023-223438

(51) Int. Cl. H01M 50/571; H01M 10/44; H01M 10/54; H01M 50/562

(52) U.S. Cl. CPC H01M 50/571; H01M 10/44; H01M 50/562; H01M 10/54

(57) ABSTRACT

A main object of the present disclosure is to provide a method for disposing of a battery, with which the battery can be deactivated well. The present disclosure achieves the object by providing a method for disposing of a battery, the method including: a soaking step of soaking a battery including an Al terminal in a treatment liquid to decrease a voltage of the battery by causing outer short circuit through the treatment liquid, wherein the treatment liquid contains water and a supporting salt; and the Al terminal includes, on at least a part of its surface, a protective layer that prevents the Al terminal from eluting to the treatment liquid.

### TECHNICAL FIELD

The present disclosure relates to a method for disposing of a battery and a battery.

### BACKGROUND ART

A battery usually includes a terminal configured to take out electricity from an electrode body that is a power generating element. For example, Patent Literature 1 discloses a battery module that includes a laminate flat exterior battery including a cathode terminal lead and an anode terminal lead, wherein the cathode terminal lead is made of aluminum. Also, Patent Literature 2 discloses that the resistance to liquid electrolyte is improved by a surface treatment of an outer package made of aluminum.

### CITATION LIST

### Patent Literatures

Patent Literature 1: Japanese Patent Application Laid-Open (JP-A) No. 2007-257849

Patent Literature 2: JP-A No. 2001-266945

### SUMMARY OF DISCLOSURE

### Technical Problem

Upon recycling a battery, it is desired to decrease the remaining voltage of the battery and deactivate the battery. Examples of the method for deactivating the battery may include a method in which the battery is soaked in a treatment liquid (such as salt water) to cause outer short circuit. In a case of the battery including an aluminum terminal (Al terminal), it may be difficult to deactivate the battery well since the Al terminal is deteriorated by the treatment liquid.

The present disclosure has been made in view of the above circumstances, and a main object thereof is to provide a method for disposing of a battery, with which the battery can be deactivated well.

### Solution to Problem

[1]

A method for disposing of a battery, the method comprising:

a soaking step of soaking a battery including an Al terminal in a treatment liquid to decrease a voltage of the battery by causing outer short circuit through the treatment liquid, wherein

the treatment liquid contains water and a supporting salt; and

the Al terminal includes, on at least a part of its surface, a protective layer that prevents the Al terminal from eluting to the treatment liquid.

[2]

The method for disposing of a battery according to [1], the method further comprising a protective layer forming step of forming the protective layer on the surface of the Al terminal before the soaking step.

[3]

The method for disposing of a battery according to [1], wherein

the battery includes an electrode body, an outer package covering the electrode body, and the Al terminal that is electrically connected to the electrode body, and is partially exposed from the outer package; and

the protective layer is formed on the surface of the Al terminal that is positioned inside the outer package.

[4]

The method for disposing of a battery according to any one of [1] to [3], wherein the protective layer is an aluminum oxide layer.

[5]

The method for disposing of a battery according to [4], wherein the aluminum oxide layer is a boehmite layer.

[6]

The method for disposing of a battery according to any one of [1] to [3], wherein the protective layer is a conductive resin layer.

[7]

The method for disposing of a battery according to any one of [1] to [3], wherein the protective layer is a plated layer.

[8]

A method for disposing of a battery, the method comprising:

a soaking step of soaking a battery including an Al terminal in a treatment liquid to decrease a voltage of the battery by causing outer short circuit through the treatment liquid, wherein

the treatment liquid contains water and a supporting salt; and

a material of the Al terminal is an Al-Mg-Si-based alloy or an Al—Ni clad material.

[9]

A battery comprising an Al terminal, wherein the Al terminal includes, on at least a part of its surface, a protective layer that prevents the Al terminal from eluting to the treatment liquid.

[10]

The battery according to [9], wherein

the battery includes an electrode body, an outer package covering the electrode body, and the Al terminal that is electrically connected to the electrode body, and is partially exposed from the outer package; and

when observed from a thickness direction, the protective layer is formed selectively in a region including an end part of the outer package side of the Al terminal.

[11]

A battery comprising an Al terminal, wherein

a material of the Al terminal is an Al-Mg-Si-based alloy or an Al—Ni clad material.

[12]

The battery according to any one of [9] to [11], wherein the battery includes a laminate-type outer package.

[13]

The battery according to any one of [9] to [12], wherein the battery is a solid state battery.

### Advantageous Effects of Disclosure

The present disclosure exhibits an effect of deactivating a battery well.

### BRIEF DESCRIPTION OF DRAWINGS

FIG. 1A is a schematic plane view and FIG. 1B is a schematic side view exemplifying the battery in the present disclosure.

FIG. 2 is a schematic side view exemplifying the method for disposing of a battery in the present disclosure.

FIGS. 3A and 3C are schematic plane views and FIGS. 3B and 3D are schematic cross-sectional views exemplifying a part of the battery and the protective layer in the present disclosure.

FIG. 4 is a schematic cross-sectional view exemplifying the protective layer in the present disclosure.

FIGS. 5A and 5B are schematic plan views exemplifying the position of the protective layer in the present disclosure.

FIGS. 6A and 6B are schematic cross-sectional views exemplifying the electrode body in the present disclosure.

FIG. 7 is a schematic side view exemplifying the method for disposing of a battery in the present disclosure.

### DESCRIPTION OF EMBODIMENTS

The method for disposing of a battery and the battery in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

### A. Method for Disposing of Battery

The method for disposing of a battery in the present disclosure can be roughly classified into two aspects. The method for disposing of a battery in the present disclosure will be explained separately in the first aspect and the second aspect.

### A-1. First Aspect

The method for disposing of a battery in the first aspect includes: a soaking step of soaking a battery including an Al terminal in a treatment liquid to decrease a voltage of the battery by causing outer short circuit through the treatment liquid, wherein the treatment liquid contains water and a supporting salt; and the Al terminal includes, on at least a part of its surface, a protective layer that prevents the Al terminal from eluting to the treatment liquid.

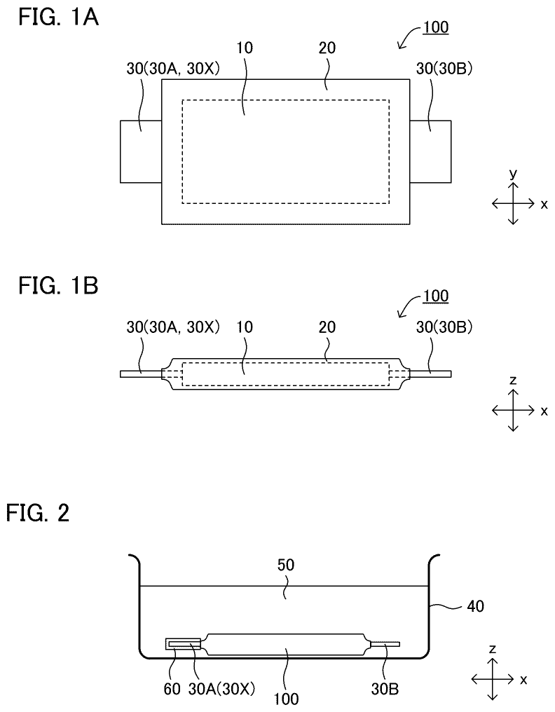

FIG. 1A is a schematic plan view and FIG. 1B is a schematic side view exemplifying the battery in the first aspect. As shown in FIGS. 1A and 1B, battery 100 includes electrode body 10, outer package 20 covering the electrode body 10, and terminal 30 (30A, 30B) that is electrically connected to the electrode body 10 and is partially exposed from the outer package 20. At least one of the terminal 30A and the terminal 30B is an Al terminal. In FIGS. 1A and 1B, the terminal 30A corresponds to Al terminal 30X.

FIG. 2 is a schematic side view exemplifying the method for disposing of a battery in the first aspect. As shown in FIG. 2, treatment liquid 50 is put in treating bath 40, and the battery 100 is soaked in the treatment liquid 50. The terminal 30A and the terminal 30B are conducted through the treatment liquid 50 to cause outer short circuit, and thereby the voltage of the battery 100 is decreased. In the first aspect, the Al terminal 30X includes, on at least a part of its surface, protective layer 60 that prevents the Al terminal 30X from eluting to the treatment liquid 50.

According to the first aspect, since the Al terminal includes the protective layer on its surface, the battery can be deactivated well. As described above, upon recycling a battery, it is desired to decrease the remaining voltage of the battery to deactivate the battery. By deactivating the battery, later steps such as a battery disassembling step can be safely performed. Examples of the method for deactivating the battery may include a method in which the battery is soaked in a treatment liquid (such as salt water) to cause outer short circuit. In a case of the battery including an Al terminal, the Al terminal is deteriorated by the treatment liquid, and it may be difficult to deactivate the battery well. For example, corrosion (elution) of the Al terminal is caused by the treatment liquid, and when the Al terminal exposed from the outer package slips, the decrease in the remaining voltage due to outer short circuit may not be caused or the decrease speed may be significantly slowed down.

In contrast, in the first aspect, the protective layer that prevents the Al terminal from eluting to the treatment liquid is formed on the surface of the Al terminal. Thereby, the deterioration of the Al terminal by the treatment liquid can be inhibited. For this reason, the outer short circuit can be maintained when the battery is soaked in the treatment liquid, and the battery can be deactivated well.

### 1. Soaking Step

The soaking step in the first aspect is a step of soaking a battery including an Al terminal in a treatment liquid to decrease a voltage of the battery by causing outer short circuit through the treatment liquid. In the first aspect, the Al terminal includes, on at least a part of its surface, a protective layer that prevents the Al terminal from eluting to the treatment liquid. The protective layer may be formed by performing a protective layer forming step before the soaking step. Details of the protective layer forming step will be described later. Incidentally, in the method for disposing of a battery in the first aspect, it is not necessary to completely prevent the deterioration of the Al terminal, but the deterioration of the Al terminal may be inhibited by the protective layer to the extent the battery can be deactivated well.

### (1) Battery

As shown in FIGS. 1A and 1B, the battery 100 usually includes the electrode body 10, the outer package 20 covering the electrode body 10, and the terminal 30 (30A, 30B) that is electrically connected to the electrode body 10, and is partially exposed from the outer package 20. Also, at least one of the terminal 30A and the terminal 30B is an Al terminal. In FIGS. 1A and 1B, the terminal 30A corresponds to Al terminal 30X.

In the first aspect, a unit configured by an electrode body, an outer package, and a pair of terminals may be referred to as a “cell”. The battery to be disposed of by the disposing method in the first aspect may include one cell, and may include a plurality of cells. A plurality of cells are usually layered in a thickness direction.

### (i) Terminal

The battery in the first aspect usually includes a cathode terminal and an anode terminal. At least one of the cathode terminal and the anode terminal is an Al terminal. Among them, at least the cathode terminal is preferably the Al terminal. The Al terminal is a terminal containing at least aluminum. The Al terminal preferably contains aluminum as a main component of the metal component. In the Al terminal, the proportion of the aluminum with respect to all the metal components is, for example, 50 weight % or more, may be 70 weight % or more, and may be 90 weight % or more. Examples of the material of the Al terminal may include aluminum and an aluminum alloy.

There are no particular limitations on the shape of the Al terminal. Also, there are no particular limitations on the thickness of the Al terminal either, but the thinner the Al terminal, the greater the influence of the deterioration of the Al terminal by the treatment liquid. The thickness of the Al terminal means the length of the Al terminal in a normal direction of a main surface (surface with the largest area) of the Al terminal. The thickness of the Al terminal is, for example, 5 mm or less, may be 3 mm or less, may be 1 mm or less, may be 0.8 mm or less, and may be 0.6 mm or less. Meanwhile, the thickness of the Al terminal is, for example, 0.1 mm or more.

The Al terminal includes, on at least a part of its surface, a protective layer that prevents the Al terminal from eluting to the treatment liquid. The Al terminal and the protective layer may be arranged so as to contact each other, and may be arranged interposing another layer.

Examples of the protective layer may include an aluminum oxide layer. The aluminum oxide layer may be formed by, for example, oxidizing the surface of the Al terminal. Incidentally, “the aluminum oxide layer” in the first aspect does not include a natural oxide film of the Al terminal. The natural oxide film is usually 5 nm or less. In contrast, the thickness of the oxide aluminum layer in the first aspect is usually larger than 5 nm.

Examples of the oxide aluminum layer may include a boehmite layer and an alumite layer. The boehmite layer is formed by, for example, performing a boehmite treatment to the Al terminal. The boehmite treatment is a kind of chemical conversion treatments, and it is a treatment to chemically form an aluminum oxide layer on a surface of the Al terminal by, for example, bringing the Al terminal into contact water or water vapor at a high temperature (such as 70° C. or more). The thickness of the boehmite layer is, for example, 100 nm or more and 2 μm or less.

The alumite layer is formed by, for example, performing an alumite treatment to the Al terminal. The alumite treatment corresponds to an anodization treatment, and it is a treatment of electrically forming the aluminum oxide layer on a surface of the Al terminal by, for example, performing an electrolytic treatment using the Al terminal as an anode. The thickness of the alumite layer is, for example, 0.5 μm or more and 50 μm or less, and may be 1 μm or more and 20 μm or less. Also, in the first aspect, the aluminum oxide layer may be formed by heating the surface of the Al terminal.

Other examples of the protective layer may include a conductive resin layer. The conductive resin layer includes, for example, a resin (including rubber) and a conductor. Examples of the resin may include a polyolefine-based resin such as polyethylene, polypropylene, and polystyrene; an imide-based resin such as polyimide and polyamideimide; an amide-based resin such as polyamide; an acrylic-based resin such as polymethylacrylate, polyethylacrylate, polypropylacrylate, polybutylacrylate, polyhexylacrylate, poly2-ethylhexylacrylate, polydecylacrylate, and polyacrylate; a methacrylate-based resin such as polymethylmethacrylate, polyethylmethacrylate, polybutylmethacrylate, poly2-ethylhexylmethacrylate, and polymethacrylate; a polycarbonate-based resin such as polyitaconic acid, polycrotonic acid, polyfumaric acid, polyangelic acid, and carboxymethylcellulose; a fluorine-based resin such as polyvinylydene fluoride (PVDF), a polyvinylydene-polyhexafluoro polypropylene copolymer (PVDF-HFP), and polytetra fluoro ethylene; and a rubber such as a butadiene rubber, a hydride butadiene rubber, a styrene butadiene rubber (SBR), a hydride styrene butadiene rubber, a nitrile butadiene rubber, a hydride nitrile butadiene rubber, an ethylene propylene rubber, and a fluorine rubber. Meanwhile, examples of the conductor may include a carbon material, a metal particle, and a conductive polymer. Examples of the carbon material may include a particulate carbon material such as acetylene black (AB) and Ketjen black (KB), and a fiber carbon material such as carbon fiber, carbon nanotube (CNT), and carbon nanofiber (CNF). Examples of the method for forming the conductive resin layer may include a method in which a slurry containing a resin, a conductor and a solvent is applied on the Al terminal and dried.

Further other examples of the protective layer may include a plated layer. The metal included in the plated layer may be a metal with lower ionizing tendency (metal of which natural potential is noble) than that of the Al terminal. The metal with lower ionizing tendency than that of the Al terminal has high resistance to the treatment liquid. Examples of such a metal may include iron, an iron alloy, titanium, a titanium alloy, copper, a copper alloy, lead, a lead alloy, gold, a gold alloy, silver, a silver alloy, palladium, and a palladium alloy. Incidentally, since the treatment liquid does not usually enter between the plated layer and the Al terminal, corrosion (galvanic corrosion) of the Al terminal does not occur. Meanwhile, the metal may be a metal of which ionizing tendency is equivalent to that of the Al terminal, or a metal with higher ionizing tendency (metal of which natural potential is base) than that of the Al terminal. Examples of such a metal may include magnesium, a magnesium alloy, zinc, and a zinc alloy. When such a metal is used, although the corrosion of the Al terminal does not occur, since the corrosion of the plated layer proceeds, for example, it is preferable to set the thickness of the plated layer to be sufficiently large. Examples of the method for forming the plated layer may include an electrolyte plating method and a non-electrolyte plating method.

The thickness of the protective layer is not particularly limited, and for example, it is 10 nm or more, may be 50 nm or more, may be 100 nm or more, and may be 500 nm or more. Meanwhile, the thickness of the protective layer is, for example, 50 μm or less.

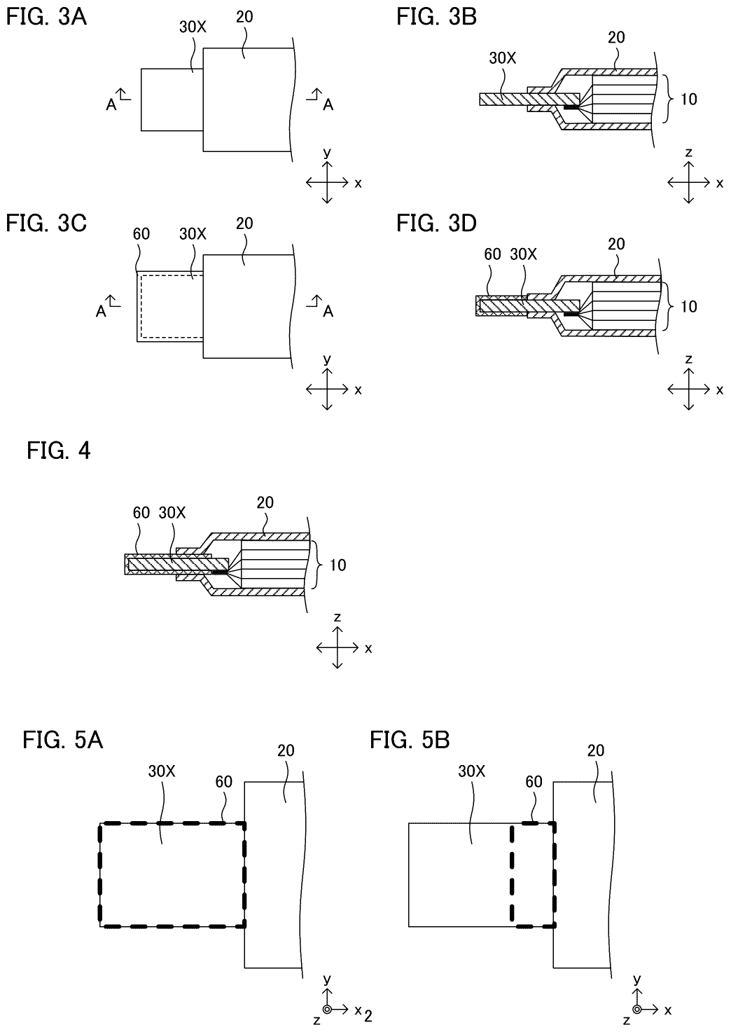

FIG. 3A is a schematic plan view exemplifying a part of the battery (before forming the protective layer) in the present disclosure, and FIG. 3B is a cross-sectional view of A-A in FIG. 3A. FIG. 3C is a schematic plan view exemplifying a part of the battery (before forming the protective layer) in the present disclosure, and FIG. 3D is a cross-sectional view of A-A in FIG. 3C. As shown in FIGS. 3A and 3B, the Al terminal 30X is electrically connected to the electrode body 10, and partially exposed from the outer package 20. In the first aspect, before the soaking step, as shown in FIGS. 3C and 3D, protective layer 60 covering at least a part of the Al terminal 30X may be formed (protective layer forming step). Meanwhile, in the first aspect, the protective layer forming step may not be performed before the soaking step. In other words, the battery before performing the method for disposing of a battery in the first aspect may include the protective layer in advance. In this case, as shown in FIG. 4, the protective layer 60 may be formed on a surface of the Al terminal 30X positioned inside the outer package 20. On the contrary, as shown in FIG. 3D, the protective layer 60 may not be formed on the surface of the Al terminal 30X positioned inside the outer package 20.

As shown in FIGS. 3C, 3D and FIG. 4, the protective layer 60 may be formed all over the Al terminal 30X exposed from the outer package 20. Meanwhile, although not illustrated in particular, the protective layer may be formed partially on the Al terminal exposed from the outer package. Also, as shown in FIGS. 3C, 3D and FIG. 4, the protective layer 60 may be formed on both sides of the main surface of the Al terminal 30X exposed from the outer package 20. Meanwhile, although not illustrated in particular, the protective layer may be formed on just one side of the main surface of the Al terminal exposed from the outer package.

As shown in FIG. 5A, when observed from the thickness direction (z direction), the protective layer 60 may be formed to cover the Al terminal 30X entirely. Meanwhile, as shown in FIG. 5B, when observed from the thickness direction (z direction), the protective layer 60 may be formed to cover the Al terminal 30X partially. In FIG. 5B, the protective layer 60 is formed selectively in a region (root region) including an end part of the outer package 20 side of the Al terminal 30X. By protecting the region including the end part of the outer package 20 side of the Al terminal 30X, when the battery is soaked in the treatment liquid, the outer short circuit can be further maintained, and the battery may be deactivated further well. Also, when the battery before performing the method for disposing of a battery in the first aspect includes the protective layer covering selectively in a region including the end part of the outer package side of the Al terminal in advance, the later described protective layer forming step can be omitted while suppressing the resistance increase due to the protective layer. Also, “the protective layer is formed to cover selectively in a region including an end part of the outer package side of the Al terminal” means that there is a region where the protective layer 60 is not formed in the opposite side to the outer package 20 side of the root region as shown in FIG. 5B. Also, from the thickness direction, when Sₐ designates an area of the Al terminal, and S_{b} designates an area of a region where the Al terminal overlaps with the protective layer, a rate of the area S_{b} with respect to the area Sₐ, which is S_{b}/Sₐ is not particularly limited, but for example, it is 10% or more, may be 30% or more, may be 50% or more, and may be 70% or more.

### (ii) Electrode Body

The electrode body in the first aspect works as a power generating element of the battery. The electrode body usually includes layers in an order of, a cathode current collector, a cathode active material layer, an electrolyte layer, an anode active material layer, and an anode current collector, in a thickness direction.

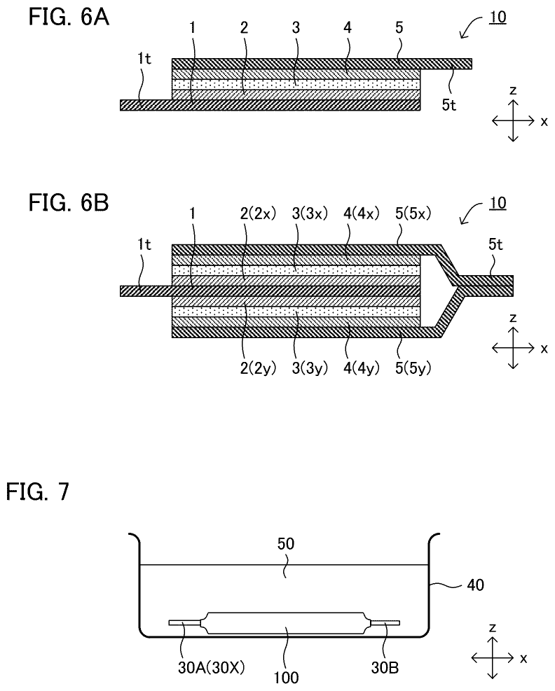

FIGS. 6A and 6B are schematic cross-sectional views exemplifying the electrode body in the first aspect. Electrode body 10 shown in FIG. 6A includes layers in an order of, anode current collector 1, anode active material layer 2, electrolyte layer 3, cathode active material layer 4 and cathode current collector 5, in a thickness direction (z direction). Also, the anode current collector 1 includes anode tab 1t configured to connect to an anode terminal (not illustrated), and the cathode current collector 5 includes cathode tab 5t configured to connect to a cathode terminal (not illustrated).

The electrode body 10 illustrated in FIG. 6B includes, anode current collector 1, and layers arranged in the order in the thickness direction (z direction) from one surface of the anode current collector 1, that are anode active material layer 2x, electrolyte layer 3x, cathode active material layer 4x and cathode current collector 5x, and layers arranged in the order in the thickness direction (z direction) from the other surface of the anode current collector 1, that are anode active material layer 2y, electrolyte layer 3y, cathode active material layer 4y and cathode current collector 5y.

In FIGS. 6A and 6B, the cathode tab 5t and the anode tab 1t are arranged so as to face to each other in the side surface of the electrode body 10 to form a so-called double-tab structure. Meanwhile, although not illustrated in particular, the cathode tab and the anode tab may be arranged on the same side surface of the electrode body to form a so-called single-tab structure. Also, as shown in FIGS. 6A and 6B, the electrode body 10 may be in a sheet shape. Also, although not illustrated in particular, the electrode body may be in a winding shape. Also, a unit configured by a cathode active material layer, an electrolyte layer and an anode active material layer may be referred to as a “power generating unit”. The electrode body in the first aspect may include one of the power generating unit, and may include a plurality of the power generating unit. A plurality of the power generating unit is usually layered in a thickness direction.

The cathode active material layer contains at least a cathode active material. The cathode active material layer may further contain at least one of an electrolyte, a conductive material, and a binder. Examples of the cathode active material may include an oxide active material. Examples of the oxide active material may include a rock salt bed type active material such as LiNi_{1/3}co_{1/3}Mn_{1/3}O₂, and LiNi_{0.8}Co_{0.15}Al_{0.05}O₂; a spinel type active material such as LiMn₂O₄; and an olivine type active material such as LiFePO₄. Examples of the shape of the cathode active material may include a granular shape.

The electrolyte may be a solid electrolyte and may be an electrolyte solution (liquid electrolyte). The solid electrolyte may be an organic solid electrolyte such as a gel electrolyte, and may be an inorganic solid electrolyte such as a sulfide solid electrolyte and an oxide solid electrolyte. Among those, the solid electrolyte is preferably a sulfide solid electrolyte. The reason therefor is its high ion conductivity. Meanwhile, there are no particular limitations on the electrolyte solution, and known electrolytes may be used. Also, examples of the conductive material may include a carbon material. Also, examples of the binder may include a rubber-based binder and a fluoride-based binder.

The anode active material layer contains at least an anode active material. The anode active material layer may further contain at least one of an electrolyte, a conductive material, and a binder. Examples of the anode active material may include a metal active material such as Li, Si and Sn, a carbon active material such as graphite, and an oxide active material such as Li₄Ti₅O₁₂.

The electrolyte layer is arranged between the cathode active material layer and the anode active material layer, and contains at least an electrolyte. The electrolyte may be a solid electrolyte and may be an electrolyte solution. The electrolyte is in the same contents as those described above. The electrolyte layer may be a solid electrolyte layer containing a solid electrolyte. Further, the solid electrolyte is preferably a sulfide solid electrolyte. Also, in general, a battery including the solid electrolyte layer containing an inorganic solid electrolyte is called a solid state battery. The solid state battery may be a semisolid state battery and may be an all solid state battery. In the present disclosure, the semisolid state battery is a battery in which the electrolyte layer includes an inorganic solid electrolyte and a liquid component (such as ionic solution). In the present disclosure, the all solid state battery is a battery in which the electrolyte layer includes only the inorganic solid electrolyte as the electrolyte.

The cathode current collector collects currents of the cathode active material layer. Examples of the material for the cathode current collector may include a metal such as aluminum, SUS, and nickel. Examples of the shape of the cathode current collector may include a foil shape. The cathode current collector usually includes a cathode tab configured to connect to the cathode terminal. Also, the anode current collector collects currents of the anode active material layer. Examples of the material for the anode current collector may include a metal such as copper, SUS, and nickel. Examples of the shape of the anode current collector may include a foil shape. The anode current collector usually includes an anode tab configured to connect to the anode terminal.

(iii) Outer Package

The outer package in the first aspect may be a laminate type outer package, and may be a case type outer package. The laminate type outer package is also called a pouch type outer package, and is an outer package using a laminate film. The laminate type outer package includes at least an inner side resin layer and a metal layer. The inner side resin layer works as a sealant layer. The inner side resin layer preferably contains a thermoplastic resin. Examples of the thermoplastic resin may include polyolefin such as polyethylene and polypropylene; polystyrene; and polyvinyl chloride. The thickness of the inner side resin layer is not particularly limited, and for example, it is 30 μm or more and 150 μm or less.

The metal layer works as a barrier layer. Examples of the metal used in the metal layer may include aluminum, an aluminum alloy, and stainless steel. The thickness of the metal layer is not particularly limited, and for example, it is 20 μm or more and 100 μm or less. Also, the laminate type outer package may include an outer side resin layer in the opposite side to the inner side resin layer on the basis of the metal layer. The outer side resin layer works as an insulating layer or a protective layer. The outer side resin layer preferably contains a thermoplastic resin. Examples of the thermoplastic resin may include polyester such as polyethylene terephthalate (PET); and nylon. The thickness of the outer side resin layer is not particularly limited, and for example, it is 20 μm or more and 100 μm or less.

The case type outer package is, for example, an outer package made of metal. Examples of the material configuring the case type outer package may include a metal aluminum and an aluminum alloy. Also, a plastic processing may be performed to aluminum or an aluminum alloy, and the material processed and cured may be used. Also, the thickness of the case type outer package is not particularly limited, and selected to the extent the desired rigidity can be obtained.

### (iv) Battery

Examples of the battery in the first aspect may include a secondary battery such as a lithium ion secondary battery. Also, examples of the applications of the battery before performing the disposing method in the first aspect may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably a battery that was used as a power source for driving hybrid electric vehicles (HEV), plug-in hybrid electric vehicles (PHEV), and battery electric vehicles (BEV). It may be a battery that was used as a power source for moving bodies other than vehicles (such as rail road transportation, vessel and airplane), and may be a battery that was used as a power source for electronic products such as information processing equipment.

### (2) Treatment Liquid

The treatment liquid in the first aspect contains water and a supporting salt.

The supporting salt is used to improve the conductivity of the treatment liquid. Also, the supporting salt usually does not include a function to prevent the Al terminal from eluting. The supporting salt includes a cation component and an anion component. Examples of the cation component of the supporting salt may include an alkali metal ion such as Na and K; and an alkali earth metal ion such as Mg and Ca. Meanwhile, examples of the anion component of the supporting salt may include a chloride ion. Specific examples of the supporting salt may include NaCl, KCl, MgCl₂, and CaCl₂. Also, the treatment liquid may contain just one kind of the supporting salt, and may contain two kinds or more of the supporting salt.

At least a part of the supporting salt is dissolved in water. The concentration of the supporting salt in the treatment liquid is not particularly limited, but for example, it is 0.01 mol/kg or more and 5.0 mol/kg or less, and may be 0.1 mol/kg or more and 3.0 mol/kg or less. In the first aspect, the concentration of the supporting salt is defined as a ratio of number of moles of the supporting salt with respect to the weight of water included in the treatment liquid. Also, examples of the method for preparing the treatment liquid may include a method in which the supporting salt is dissolved in water.

### (3) Soaking Step

In the soaking step of in the first aspect, a battery including an Al terminal is soaked in a treatment liquid to decrease a voltage of the battery by causing outer short circuit through the treatment liquid. In specific, as shown in FIG. 2, treatment liquid 50 is put in treating bath 40, and battery 100 is soaked in the treatment liquid 50.

There are no particular limitations on the temperature of the treatment liquid in the soaking step. For example, since the freezing point of salt water is about −20° C., the temperature of the treatment liquid is preferably −20° C. or more, and more preferably 0° C. or more. Meanwhile, the temperature of the treatment liquid is, for example, 60° C. or less and may be 40° C. or less. Also, the temperature of the treatment liquid in the soaking step may be the same as the room temperature.

There are no particular limitations on the treatment time in the soaking step, but from the view point of workability, for example, it is preferably 1 hour or more and 50 hours or less, and more preferably 2 hours or more and 25 hours or less.

### 2. Protective Layer Forming Step

The method for disposing of a battery in the first aspect may include a protective layer forming step of forming the protective layer on the surface of the Al terminal before the soaking step.

The method for forming the protective layer is not particularly limited, and appropriately selected depending on the kind of the protective layer. The specific examples of the method for forming the protective layer are as described above.

### A-2. Second Aspect

The method for disposing of a battery in the second aspect includes a soaking step of soaking a battery including an Al terminal in a treatment liquid to decrease a voltage of the battery by causing outer short circuit through the treatment liquid, wherein the treatment liquid contains water and a supporting salt; and a material of the Al terminal is an Al-Mg-Si-based alloy or an Al—Ni clad material.

FIG. 1A is a schematic plan view and FIG. 1B is a schematic side view exemplifying the battery in the second aspect. As shown in FIGS. 1A and 1B, battery 100 includes electrode body 10, outer package 20 covering the electrode body 10, and terminal 30 (30A, 30B) that is electrically connected to the electrode body 10 and is partially exposed from the outer package 20. At least one of the terminal 30A and the terminal 30B is an Al terminal. In FIGS. 1A and 1B, the terminal 30A corresponds to Al terminal 30X.

FIG. 7 is a schematic side view exemplifying the method for disposing of a battery in the second aspect. As shown in FIG. 7, treatment liquid 50 is put in treating bath 40, and battery 100 is soaked in the treatment liquid 50. The terminal 30A and the terminal 30B are conducted through the treatment liquid 50 to cause outer short circuit, and thereby the voltage of the battery 100 is decreased. In the second aspect, a material of the Al terminal 30X is an Al-Mg-Si-based alloy or an Al—Ni clad material.

According to the second aspect, since the material of the Al terminal is the specified material, the battery can be deactivated well. In specific, since the material of the Al terminal is the specified material, the deterioration of the Al terminal due to the treatment liquid can be inhibited. For this reason, the outer short circuit can be maintained when the battery is soaked in the treatment liquid, and the battery can be deactivated well.

The soaking step in the second aspect is a step of soaking a battery including an Al terminal in a treatment liquid to decrease a voltage of the battery by causing outer short circuit through the treatment liquid. In the second aspect, the material of the Al terminal is an Al-Mg-Si-based alloy or an Al—Ni clad material.

The Al-Mg-Si-based alloy is a so-called 6000 series aluminum alloy, which is an aluminum alloy formed by adding Mg (magnesium) and Si (silicon) to Al (aluminum) to increase the corrosion resistance. The Al-Mg-Si-based alloy contains at least Al, Mg and Si, and may further contain one kind or two kinds or more of a small amount of a metal element (including semimetal element). Examples of the small amount of the metal element may include Cu, Mn, Fe Cr, Ti, B, Zn and Zr. Also, the content of Al in the Al-Mg-Si-based alloy is, for example, 50 weight % or more, may be 70 weight % or more, and may be 90 weight % or more.

The Al—Ni clad material is a clad material including a Ni (nickel) layer on the surface of the Al (aluminum) layer. The Al—Ni clad material may include the Ni layer on one surface of the Al layer, and may include the Ni layer on both surfaces of the Al layer. Also, the Al—Ni clad material may be an overlay clad material, may be an inlay clad material, and may be an edgelay clad material.

Details of the soaking step and the battery in the second aspect are in the same contents as those described in the first aspect above; thus, the descriptions herein are omitted.

### B. Battery

The battery in the present disclosure is a battery including an Al terminal, and the Al terminal may include, on at least a part of its surface, a protective layer that prevents the Al terminal from eluting to a treatment liquid. Also, the battery in the present disclosure is a battery including an Al terminal, and a material of the Al terminal may be an Al-Mg-Si-based alloy or an Al—Ni clad material.

According to the present disclosure, the Al terminal includes the protective layer on its surface, or the material of the Al terminal is the specified material, and thus the battery can be deactivated well upon recycling. The battery in the present disclosure is in the same contents as those described in “A. Method for disposing of battery” above; thus, the descriptions herein are omitted.

The present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SIGNS LIST

1 anode current collector
2 anode active material layer
3 electrolyte layer
4 cathode active material layer
5 cathode current collector
10 electrode body
20 outer package
30 terminal
40 treating bath
50 treatment liquid
60 protective layer
100 battery

What is claimed is:

1. A method for disposing of a battery, the method comprising:
a soaking step of soaking a battery including an Al terminal in a treatment liquid to decrease a voltage of the battery by causing outer short circuit through the treatment liquid, wherein
the treatment liquid contains water and a supporting salt; and
the Al terminal includes, on at least a part of its surface, a protective layer that prevents the Al terminal from eluting to the treatment liquid.

2. The method for disposing of a battery according to claim 1, the method further comprising a protective layer forming step of forming the protective layer on the surface of the Al terminal before the soaking step.

3. The method for disposing of a battery according to claim 1, wherein
the battery includes an electrode body, an outer package covering the electrode body, and the Al terminal that is electrically connected to the electrode body, and is partially exposed from the outer package; and
the protective layer is formed on the surface of the Al terminal that is positioned inside the outer package.

4. The method for disposing of a battery according to claim 1, wherein the protective layer is an aluminum oxide layer.

5. The method for disposing of a battery according to claim 4, wherein the aluminum oxide layer is a boehmite layer.

6. The method for disposing of a battery according to claim 1, wherein the protective layer is a conductive resin layer.

7. The method for disposing of a battery according to claim 1, wherein the protective layer is a plated layer.

8. A method for disposing of a battery, the method comprising:
a soaking step of soaking a battery including an Al terminal in a treatment liquid to decrease a voltage of the battery by causing outer short circuit through the treatment liquid, wherein
the treatment liquid contains water and a supporting salt; and
a material of the Al terminal is an Al-Mg-Si-based alloy or an Al—Ni clad material.

9. A battery comprising an Al terminal, wherein
the Al terminal includes, on at least a part of its surface, a protective layer that prevents the Al terminal from eluting to a treatment liquid, or
a material of the Al terminal is an Al-Mg-Si-based alloy or an Al—Ni clad material.

10. The battery according to claim 9, the battery comprising:
an electrode body, an outer package covering the electrode body, and the Al terminal that is electrically connected to the electrode body, and is partially exposed from the outer package, wherein
when observed from a thickness direction, the protective layer is formed selectively in a region including an end part of the outer package side of the Al terminal.

11. The battery according to claim 9, wherein the battery includes a laminate-type outer package.

12. The battery according to claim 9, wherein the battery is a solid state battery.
